(19) United States
(12) Patent Application Publication
(10) Pub. No.: US 2026/0005631 A1
(43) Pub. Date: Jan. 1, 2026

(54) INVERTER CONTROL DEVICE AND AN INVERTER CONTROL METHOD

(71) Applicant: Renesas Electronics Corporation, Tokyo (JP)

(72) Inventor: Chengzhe LI, Tokyo (JP)

(21) Appl. No.: 18/756,035

(22) Filed: Jun. 27, 2024

(51) Int. Cl. H02P 21/22

(52) U.S. Cl. CPC H02P 21/22

(57) ABSTRACT

In inverter control of a motor, an inverter control method is provided that increases system efficiency in all speed ranges from low speed to high speed based on system efficiency. Specifically, the inverter control method of switching between overmodulation control and rectangular wave control, especially in the medium to high-speed range is provided, with taking system efficiency into consideration.

### BACKGROUND

The present invention relates to an inverter controller and an inverter control method in motor control of an automobile.

### The Background of the Invention

Recently, xEV automobiles such as electric vehicles (Electric Vehicle), hybrid vehicles (HEV: Hybrid Elecrtic Vehicle) and plug-in hybrid vehicles (PHEV: Plug-in Hybrid Electric Vehicle) have become popular. Electric vehicles, for example, cannot replenish electricity at regular gas stations because they run only on motors powered by electricity, and they are powered by household electrical outlets or use charging stations installed on highways or in large commercial facilities.

However, the improvement of the charging station has not yet kept pace with the popularization, and the user who possesses xEV vehicle is required to increase the running distance by charging the battery as much as possible, and in order to respond to this, the motor control of the high-efficiency so as to extend the running distance of the battery is required. The device for driving the motor is an inverter, the inverter is a device for converting DC power into AC power.

Overmodulation control and rectangular wave control are used as methods of voltage utilization factor improvement of inverters. Generally, the sine wave control system is used in the low-speed range, and the overmodulation control is used in the medium-speed range. In the high-speed range, rectangular wave control is used to maximize the voltage utilization. Conventionally, the threshold of the voltage utilization factor is used to switch between the low-speed and high-speed ranges.

There are disclosed techniques listed below.

[Patent Document 1] International Publication No. WO2010/086974

Patent Document 1 discloses the control system of the motor, three control systems of sine wave PWM control, overmodulation PWM control, and rectangular wave control.

FIG. 8 is a diagram for explaining an example of a switching method of a control method in motor control in Patent Document 1.

Control switching of the inverter according to the prior art, as shown, toward the larger side from the torque command and the rotational speed of the motor is small side, a sine wave control method, overmodulation control method, so that a rectangular wave control method, the range of the sine wave control method (sine wave range), the range of the overmodulation control method (overmodulation range), the rectangular wave control method.

It is defined in the order of the range (rectangular wave range). The motor and the inverter generally have better output responsiveness and controllability of the motor in the order of the rectangular wave control method, the overmodulation control method, and the sine wave control method, the output power is reduced, the switching loss of the plurality of switching elements of the inverter is increased.

Therefore, in the range of low rotational speed and low torque, the output responsiveness and controllability of the motor can be improved by controlling the inverter with a sine wave control method. On the other hand, in the high rotational speed and high torque range, the output power is increased and the switching loss of the inverter is reduced by controlling the inverter with the rectangular wave control method.

### SUMMARY

In the conventional method disclosed in Patent Document 1, the threshold value of the switching of the overmodulation range and the rectangular wave range has a fixed value. That is, when the modulation rate of the voltage is less than the threshold 1 is sinusoidal PWM control (A1), between the threshold 1 and the threshold 2 overmodulation PWM control (A2), when the threshold 2 exceeds rectangular wave control (A3) is performed. However, in an actual system, the system efficiency changes when conditions such as bus voltage, carrier frequency, and temperature change. In order to increase the system efficiency, it is necessary to calculate the optimum threshold considering various conditions.

According to an embodiment, the inverter control of the motor, based on the system efficiency in the range of any speed from low speed to high speed, and adopts a control scheme such that the system efficiency becomes higher. Specifically, considering the system efficiency, we provide a technique for switching overmodulation control and rectangular wave control, especially in the medium and high-speed range.

According to the embodiment, when the inverter operates in the motor, the operation by the control system considering the system efficiency becomes possible.

### BRIEF DESCRIPTION OF THE DRAWINGS

FIG. 1 is a configuration diagram of an inverter control system a control unit for performing inverter control in the present embodiment.

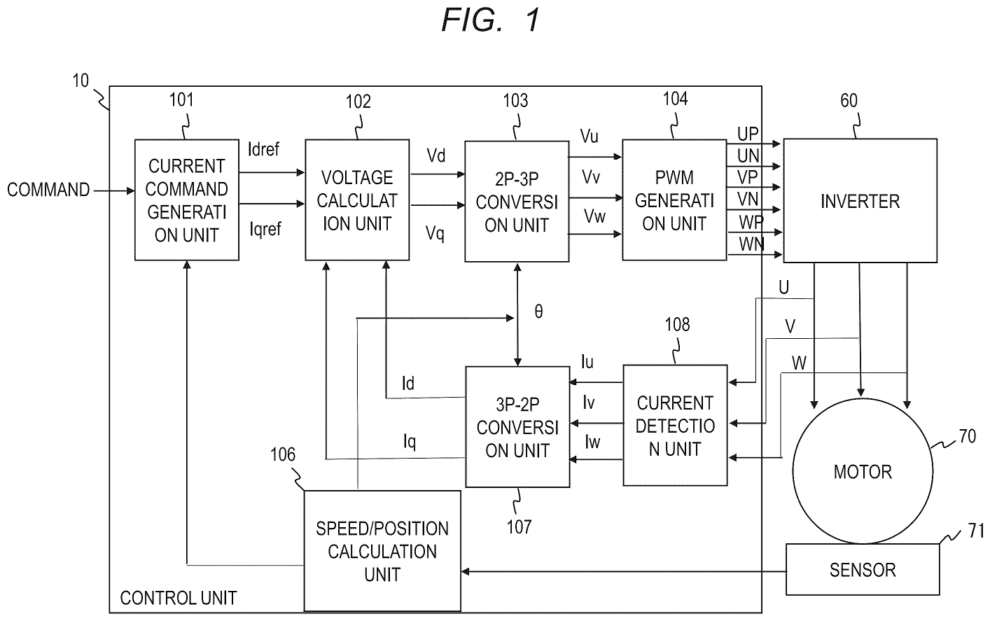

FIG. 2 is a configuration diagram of a current command generation unit in the present embodiment.

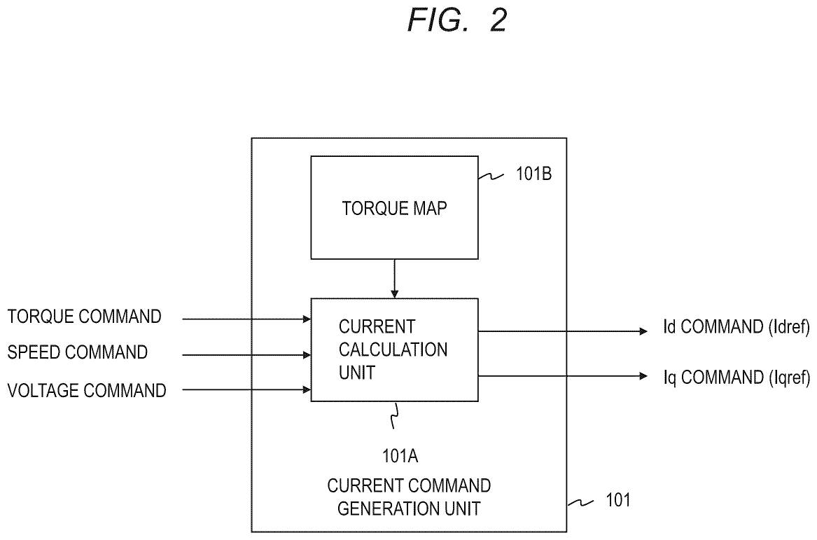

FIG. 3 is a flow diagram for explaining a measurement flow create for torque map creation.

FIG. 4 is a flow diagram for explaining the inverter control method in the present embodiment.

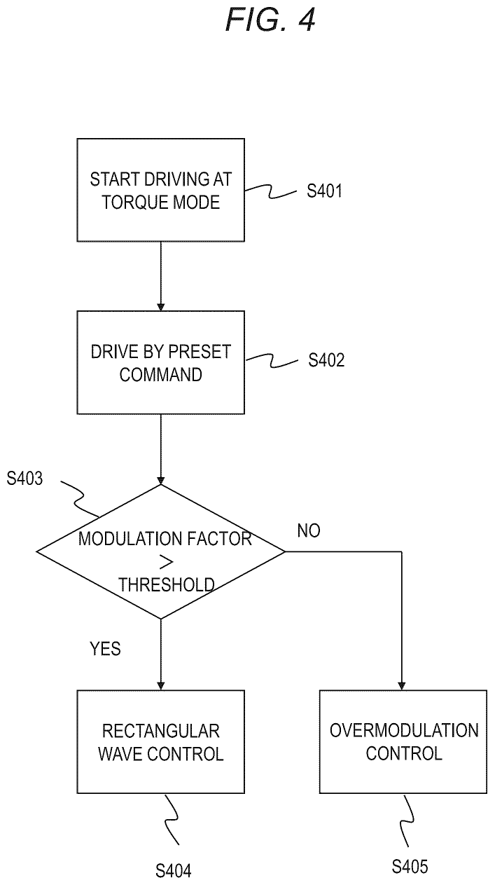

FIG. 5 is a diagram for explaining an inverter control method in the present embodiment.

FIG. 6 is a configuration diagram of a current command value generation unit in a modification.

FIG. 7 is a diagram for explaining an inverter control method in the second embodiment.

FIG. 8 is a diagram for explaining an inverter control method according to the prior art.

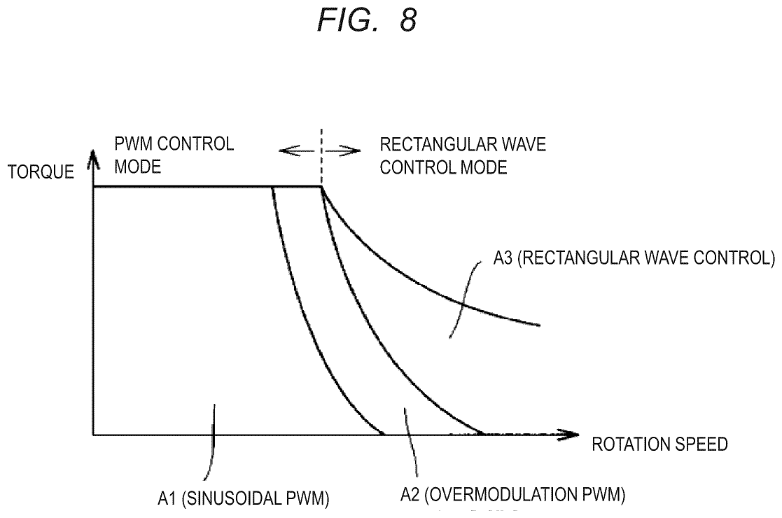

### DETAILED DESCRIPTION

Hereinafter, a software update system according to an embodiment will be described in detail by referring to the drawings. In the specification and the drawings, the same or corresponding form elements are denoted by the same reference numerals, and a repetitive description thereof is omitted. In the drawings, for convenience of description, the configuration may be omitted or simplified. Also, at least some of the embodiments may be arbitrarily combined with each other.

### First Embodiment

The control method of the motor 70 by the control unit 10 in this embodiment will be described in detail.

Current command generation unit receives a torque command value inputted to the control unit 10 from the electronic control unit (ECU) (not shown) provided externally, the current command generation unit 101 calculates a d-axis current command value Id and the q-axis current command value Iq corresponding to the torque command value and the motor rotational speed from the map is set in advance It is outputted to the voltage calculation unit 102. Here, the motor rotation speed uses a value calculated by the speed position calculation unit 106 based on the detected value θ by the sensor.

The voltage calculation unit 102 outputs the d-axis voltage command value Vd and the q-axis voltage command value Vq for matching the d-axis real current value Id and q-axis real current Iq output by the three-phase two-phase converter 107 to the d-axis current command value Idref and the q-axis current command value Iqref respectively by calculating PI calculation to the two-phase three-phase converter 103. The d-axis real current Id and q-axis real current Iq here, in the three-phase to two-phase conversion unit 102, using a value obtained by converting each phase current Iu, Iv, Iw of the three phases detected by the current detecting unit 108 based on the motor rotational angle theta.

The two-phase to three-phase conversion unit 103 conversions the d-axis voltage command Vd and the q-axis voltage command Vq based on the rotational angle θ of the motor to each phase voltage Vu, Vv, Vw of the three-phase and outputs it to PWM generation unit 104. Incidentally, the conversion from the d-axis voltage command Vd and the q-axis voltage command Vq to each phase voltage Vu, Vv, Vw of the three-phase, system voltage VH is also reflected.

The PWM generation unit 104, based on the three-phase voltage Vu, Vv, Vw and comparative with a predetermined carrier, and generates a switching signal (UP, UN, VP, VN, Wp, WN) and outputs it to the inverter 60. Thus, by each switching element of the inverter 60 is switching controlled, a voltage for outputting a torque corresponding to the torque command value is applied to the motor 70.

The three-phase two-phase conversion unit 107 conversions each phase current Iu, Iv, Iw of the three phases detected by the current detecting unit 108 into d-axis real current Id and q-axis real current Iq based on the motor rotational angle θ and outputs it to the current command generation unit 101.

### Generation of a Torque Map

The torque map is used to retrieve the d-axis current command value Id and the q-axis current command value Iq from command values such as torque, speed, and voltage. The data of the torque map is written to and used in a memory (not shown) such as a memory control unit (MCU).

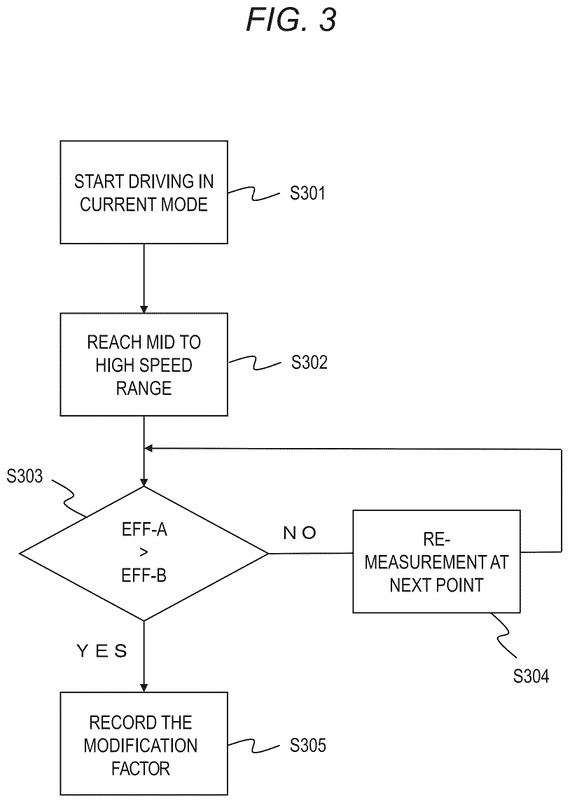

FIG. 3 is a flow diagram for explaining a measurement flow create for torque map generation.

The torque map is measured in current-mode using a measuring device such as a real machine and a power analyzer (in step S301). The velocity of the actual device is in the middle and high-speed range, and the overmodulation control method is entered (in step S302). Adjust the current command value and advance angle to measure the d-axis current value Id and the q-axis current value Iq when the target torque is reached. Based on the measured values, the system efficiency (system efficiency A) in the overmodulation control system and the system efficiency (system efficiency B) in the rectangular wave control system are calculated and compared (in step S303).

When the system efficiency (system high rate A) in the overmodulation control scheme is large in the system efficiency (system efficiency B) in the rectangular wave control scheme (YES in step S303), the modulation rate at this point is recorded as thresholds. If the above thresholds operate in the rectangular wave control method (in step S304). When the modulation inverter control system is in feed-forward control, the modulation factor m is calculated using the d-axis voltage Vd, the q-axis voltage Vq, and the bus voltage Vdc as shown below.

$$Calculation of moodulation factor m$$

$$Vd = Id \times Rs + ω \times Lq \times Iq + Pout \\ Vq = Iq \times Iq \times Rs + ω \times Ld \times Id + Pout + ω \times φ m \\ Modulation indexm = \sqrt{} ( Vd \hat{} 2 + Vq \hat{} 2 ) / ( Vdc / \sqrt{} 2 ) \qquad ( 1 )$$

Id: d-axis current command
Iq: q-axis current command
Rs: Motor Phase Resistance
ω: Rotational speed
ϕm: Magnetic flux value
Pout: Output-value of P control
Vdc: Bus-voltage

$$Calculation of system efficiency$$

$$\text{System-efficiency} η = ( Pn \times ω \times T ) / ( Vdc \times Idc ) \\ \text{Inverter-input} DC \text{-voltage:} Vdc \qquad ( 2 )$$

Inverter-input DC current: Idc
Rotating Speed of Motor: ω
Motor torque: T
Number of pairs of motor poles: Pn

On the other hand, when the system efficiency (system efficiency A) in the overmodulation control scheme is smaller than the system efficiency (system efficiency B) in the rectangular wave control scheme (No in step S303), the overmodulation control scheme is continued to calculate the system efficiency at a predetermined timing (step S304). The predetermined timing, for example, to perform the measurement at a constant interval of the speed and torque (each speed 1,000 rpm, for each torque 200 Nm).

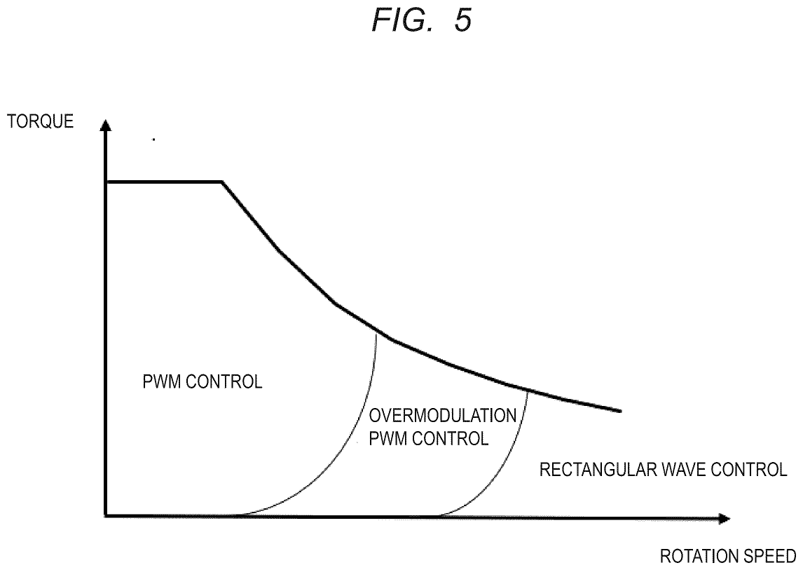

For example, as shown in FIG. 5, when the effective line-voltage is used as a reference in the space vector system, the modulation factor m becomes a PWM linear range between 0 and 1. The overmodulation range occurs when the modulation factor m is between 1 and 1.10. The modulation factor m becomes a rectangular wave range after 1.10. It has the effect that the switching loss decreases in the rectangular wave range.

In this embodiment, the range of application of PWM overmodulation range and the rectangular wave range is determined in view of the systematic efficiency.

### Inverter Control Method

The specific method is to create a torque map in advance such that the system efficiency is optimal by the above-described method, and set a threshold value for switching over modulation control and rectangular wave control. When actually driving a car, the torque map and threshold created are used.

Initially run in torque-mode (in step S401). Operates with preset command (in step S402). When the modulating factor m exceeds the preset thresholds (Yes in step S403), it operates in a rectangular wave control system. On the other hand, when the modulation rate m does not exceed the preset thresholds (No in step S403), it operates in the overmodulation control scheme. Conventionally, efficiency was reduced by using a fixed threshold, but in the present embodiment, the system efficiency can be increased by changing to the optimum threshold.

Specifically, as shown in FIG. 5, it operates in PWM overmodulation control system in the low-speed range, and operates by transitioning from the overmodulation control system to the rectangular wave control system in the medium-high-speed range. By this, the range of the optimum point of the system efficiency of the overmodulation range and the rectangular wave control range is extracted, and the scheme of the system maximum efficiency is always realized in the whole middle and high speed range. By increasing the efficiency of the system, the range can also be extended.

### Modification

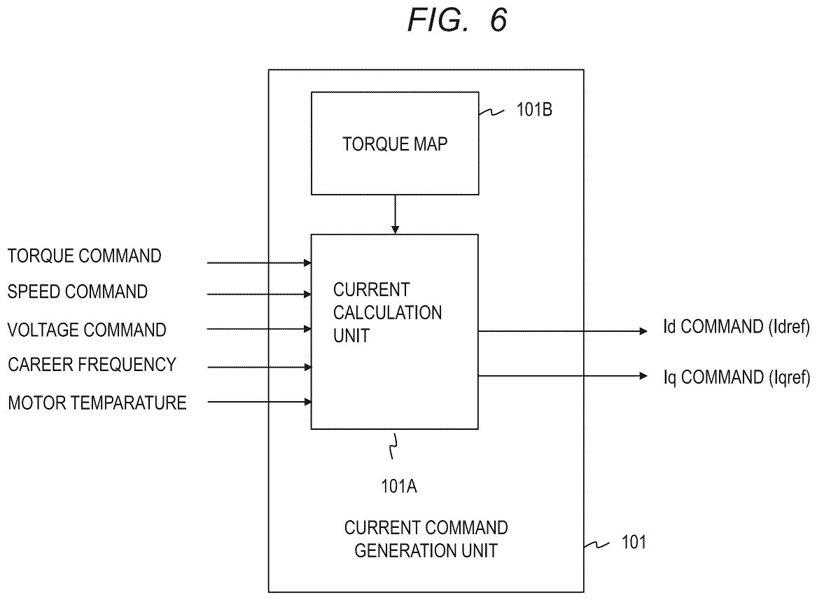

As shown in FIG. 6, the motor temperature and carrier frequency information based on the temperature sensor information are added as input parameters of the torque map to further enhance the system efficiency. Thus, even when the motor temperature and the carrier frequency fluctuate, it is possible to provide an inverter control device and an inverter control method capable of constantly improving the system efficiency.

### Second Embodiment

In the first embodiment, the torque map is calculated by measurement in advance, and the inverter control is switched while operating using the torque map. In the second embodiment, the overmodulation range and the rectangular wave control are switched by the on-line method. When the modulation factor exceeds unity, the loss of overmodulation control and rectangular wave control (e.g., switching loss and conduction loss) is calculated in real time in the model of the power module at the same time during overmodulation control. By comparing the loss, from the timing of the loss of the rectangular wave control is small, it transits to the rectangular wave control.

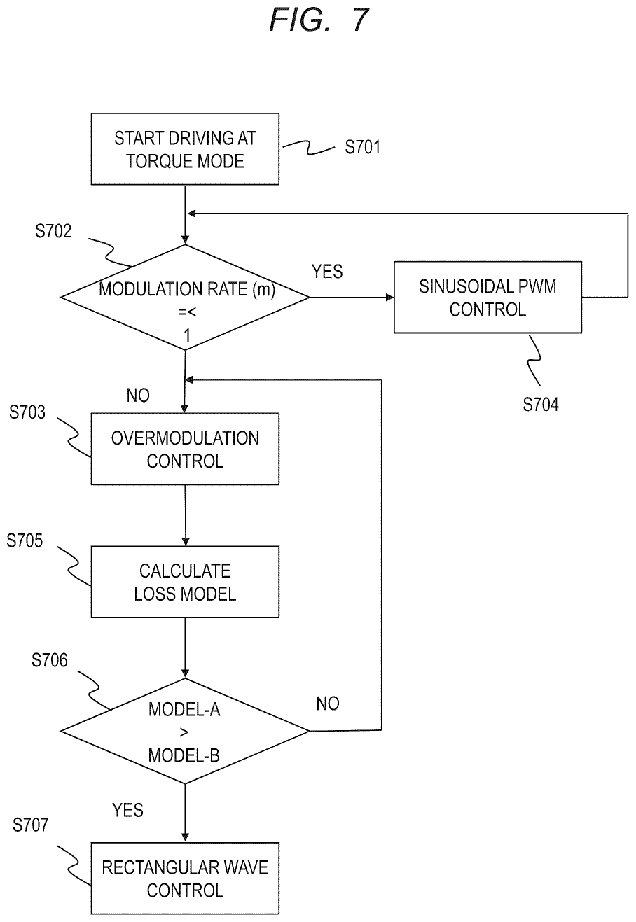

FIG. 7 is a flowchart for explaining the inverter control method in the second embodiment.

Initially run in torque mode (in step S701). If the modulating factor m is 1 or less (Yes in step S702), to continue the operation in the sine wave PWM control (in step S704). On the other hand, if the modulation rate m exceeds 1 (No in step S702), performs operation instead of overmodulation control (in step S703).

A loss-model computation is then performed (in step S705). As an exemplary loss model calculation, when the inverter is IGBT, the switching loss and conduction loss are calculated to calculate the loss model.

$$Switching loss$$

$$P = 1 / 2 \times ( Vbus \times Ton + Vbus \times Toff ) \times fc \qquad ( 1 )$$

Vbus: Bus-voltage
Ton: Turn-on time
Toff: Turn-off time
Fc: Control frequency

Based on the above general mathematical equations, when comparing the switching loss based on a current waveform of one period in the overmodulation range and the rectangular wave range. The number of switching N generated in one cycle of the current in the overmodulation range is counted. For rectangular wave control, the control frequency fc is changed to the current period when the switching loss is calculated to equal the frequency to the half period of the voltage-waveform.

$$\text{Overmodulation range:} P 1 = 1 / 2 \times ( Vbus \times I \times Ton + Vbus \times I \times Toff ) * N \\ \text{Rectangular wave control:} \\ P 2 = 1 / 2 \times ( Vbus \times I \times Ton + Vbus \times I \times Toff ) \times 2$$

$$Conduction loss$$

$$P = ( Vce \times I ) \times Duty \qquad ( 2 )$$

Vce: Collector-saturation-voltage
I: Electric current
Duty: On Duty

Based on the above general mathematical equations, when comparing the switching loss based on a current waveform of one period in the overmodulation range and the rectangular wave range. One-period average duty_1 of the current is used in the overmodulation range.

$$\text{Overmodulation range:} P 3 = ( Vce \times I ) \times Duty\_ 1 \\ \text{Rectangular wave control:} \\ P 4 = ( Vce \times I ) Duty = 1 for rectangular wave control$$

### (3) Loss Model

Overmodulation range: P1+P3
Rectangular wave control area: P2+P4

The loss model computation is performed to compare the loss model P1+P3 in the overmodulation range (loss model A) with the loss model P2+P4 in the rectangular wave control range (loss model B) (in step S706), and to switch to the rectangular wave control mode when the loss model A is larger than the loss model B (Yes in step S706). On the other hand, if the loss model A is smaller than the loss model B (No in step S706), the overmodulation control is continued.

According to the second embodiment, the switching of the optimum inverter control can be performed in real time during the actual operation of the vehicle.

Although the invention made by the present inventor has been specifically described based on the embodiment, the present invention is not limited to the embodiment described above, and it is needless to say that various modifications can be made without departing from the gist thereof.

What is claimed is:

1. An inverter control device comprising a current command value calculation unit for calculating a d-axis current command value and a q-axis current command value from the speed command value and the torque command value by a torque command value, a speed command value and a voltage command value based on a torque map;
and a voltage calculation unit for calculating a d-axis voltage value and a q-axis voltage value from the d-axis current command value and the q-axis current command value,
wherein the inverter control device calculates a modulation factor from the d-axis current command value, the q-axis current command value, the d-axis voltage value and the q-axis voltage value, and determines a control mode for performing control of a motor by comparison with a threshold value of the modulation factor,
wherein the threshold is a value set by comparing a system efficiency for each control mode of the motor.

2. The inverter control device according to claim 1,
wherein a control mode of the motor is an over-modulation control mode and a square wave control mode.

3. The inverter control device according to claim 1,
the current command value calculation unit further inputs the carrier frequency and the motor temperature, and calculates the d-axis current command value and the q-axis current command value from the torque map.

4. An inverter control device comprising a current command value calculation unit for calculating a d-axis current command value and a q-axis current command value from the speed command value and the torque command value by a torque command value, a speed command value and a voltage command value based on a torque map;
and a voltage calculation unit for calculating a d-axis voltage value and a q-axis voltage value from the d-axis current command value and the q-axis current command value,
wherein the inverter control device calculates a modulation factor from the d-axis current command value, the q-axis current command value, the d-axis voltage value and the q-axis voltage value, and determines a control mode for performing control of a motor by comparison with a threshold value of the modulation factor,
when the threshold exceeds a predetermined value, the inverter control device calculates a loss for each control mode of the motor, and performs control of the motor by the control mode with less loss.

5. The inverter control device according to claim 4,
wherein a control mode of the motor is an over-modulation control mode and a square wave control mode.

6. An inverter control method by an inverter control device comprising a current command value calculation unit for calculating a d-axis current command value and a q-axis current command value from the speed command value and the torque command value by a torque command value, a speed command value and a voltage command value based on a torque map; and a voltage calculation unit for calculating a d-axis voltage value and a q-axis voltage value from the d-axis current command value and the q-axis current command value,
wherein the inverter control device calculates a modulation factor from the d-axis current command value, the q-axis current command value, the d-axis voltage value and the q-axis voltage value, and determines a control mode for performing control of a motor by comparison with a threshold value of the modulation factor,
wherein the threshold is a value set by comparing a system efficiency for each control mode of the motor.

7. The inverter control method according to claim 6, wherein a control mode of the motor is an over-modulation control mode and a square wave control mode.

8. The inverter control method according to claim 6, the current command value calculation unit further inputs the carrier frequency and the motor temperature, and calculates the d-axis current command value and the q-axis current command value from the torque map.
